(19) United States
(12) Patent Application Publication
(10) Pub. No.: US 2019/0001714 A1
(43) Pub. Date: Jan. 3, 2019

(54) Label Medium and Cassette

(71) Applicant: Brother Kogyo Kabushiki Kaisha, Nagoya-shi (JP)

(72) Inventors: Harumitsu Inoue, Toki-shi (JP); Takaaki Banno, Nagoya-shi (JP); Yukiko Takami, Inazawa-shi (JP); Haruki Matsumoto, Nagoya-shi (JP); Takaaki Oguchi, Kasugai-shi (JP)

(21) Appl. No.: 15/939,917

(22) Filed: Mar. 29, 2018

(30) Foreign Application Priority Data
Jun. 30, 2017 (JP) 2017-129482

(51) Int. Cl. B41J 15/04; B41J 2/32; B41J 3/407

(52) U.S. Cl. CPC B41J 15/044; B41J 3/4075; B41J 2/32

(57) ABSTRACT

A label of a label medium includes: first and second indicator portions; first and second wrapping portions, one of which has an adhesive-layer-exposed portion; and first and second through portions each having at least a portion of a hole or a slit through which the adhesive-layer-exposed portion is passed. The first indicator portion, the first through portion, and the first wrapping portion are connected to each other in this order in a first direction. The second indicator portion, the second through portion, and the second wrapping portion are connected to each other in this order in the first direction or a second direction. The first indicator portion and the second indicator portion, the first through portion and the second through portion, and/or the first wrapping portion and the second wrapping portion are connected to each other via a first line.

### CROSS REFERENCE TO RELATED APPLICATION

The present application claims priority from Japanese Patent Application No. 2017-129482, which was filed on Jun. 30, 2017, the disclosure of which is herein incorporated by reference in its entirety.

### BACKGROUND

The following disclosure relates to a label medium and a cassette for creating a label to be wrapped and held on a wrapped member such as a cable.

There is known a label printed on a printed tape having an adhesive layer. The label has a label main portion and a wrapping portion. Information is printed on the label main portion based on print data. Mountain fold is performed for the label main portion along perforation, so that back surfaces of the label main portion are stuck to each other by the adhesive layer. The wrapping portion is folded back and wrapped on a wrapped member such as a cable. Back surfaces of the wrapping portion are thereby bonded to the wrapped member by the adhesive layer, and at the same time the back surfaces of the wrapping portion are bonded to each other by the adhesive layer.

### SUMMARY

The above-described label is bonded to the wrapped member by the adhesive layer. This leads to difficulty in removing the label from the wrapped member and in changing a position at which the label is held on the wrapped member.

Accordingly, an aspect of the disclosure relates to a label medium and a cassette containing the label medium for creating a label easily changeable in position with respect to the wrapped member and easily removable from the wrapped member.

One aspect of the disclosure relates to a label medium includes: a mount sheet; and a label stuck to the mount sheet via an adhesive layer and including (i) a first indicator portion and a second indicator portion each including a region on which information is directly printable or writable, (ii) a first wrapping portion and a second wrapping portion to be wrapped on a wrapped member, one of the first wrapping portion and the second wrapping portion including an adhesive-layer-exposed portion, and (iii) a first through portion and a second through portion each including at least a portion of a hole or a slit through which the adhesive-layer-exposed portion is passed, wherein the first indicator portion, the first through portion, and the first wrapping portion are connected to each other in order of the first indicator portion, the first through portion, and the first wrapping portion in a first direction parallel with a surface of the mount sheet, wherein the second indicator portion, the second through portion, and the second wrapping portion are connected to each other in order of the second indicator portion, the second through portion, and the second wrapping portion in one of the first direction and a second direction opposite to the first direction, wherein at least one pair of (a) a pair of the first indicator portion and the second indicator portion, (b) a pair of the first through portion and the second through portion, or (c) a pair of the first wrapping portion and the second wrapping portion are connected to each other via a first line, wherein at least a portion of the first indicator portion and at least a portion of the second indicator portion are symmetric with respect to an imaginary line extending along the first line, wherein at least a portion of the first through portion and at least a portion of the second through portion are symmetric with respect to the imaginary line, wherein at least a portion of the first wrapping portion and at least a portion of the second wrapping portion are symmetric with respect to the imaginary line, and wherein at least a portion of the hole or the slit of the first through portion and at least a portion of the hole or the slit of the second through portion are symmetric with respect to the imaginary line.

Another aspect of the disclosure relates to a label medium including: a mount sheet; and a label stuck to the mount sheet via an adhesive layer and including (i) a first indicator portion and a second indicator portion each including a region on which information is directly printable or writable and (ii) a first loop forming portion and a second loop forming portion for forming a loop, one of the first loop forming portion and the second loop forming portion including an adhesive-layer-exposed portion, wherein the first indicator portion and the first loop forming portion are connected to each other and arranged in order of the first indicator portion and the first loop forming portion in a first direction parallel with a surface of the mount sheet, wherein the second indicator portion and the second loop forming portion are connected to each other and arranged in order of the second indicator portion and the second loop forming portion in one of the first direction and a second direction opposite to the first direction, wherein at least one pair of (a) a pair of the first indicator portion and the second indicator portion or (b) a pair of the first loop forming portion and the second loop forming portion are connected to each other via a first line, wherein at least a portion of the first indicator portion and at least a portion of the second indicator portion are symmetric with respect to an imaginary line extending along the first line, and wherein at least a portion of the first loop forming portion and at least a portion of the second loop forming portion are symmetric with respect to the imaginary line.

Yet another aspect of the disclosure relates to a cassette containing a roll that is formed by winding a label medium around a spool, wherein the label medium includes: a mount sheet; and a label stuck to the mount sheet via an adhesive layer and including (i) a first indicator portion and a second indicator portion each including a region on which information is directly printable or writable, (ii) a first wrapping portion and a second wrapping portion to be wrapped on a wrapped member, one of the first wrapping portion and the second wrapping portion including an adhesive-layer-exposed portion, and (iii) a first through portion and a second through portion each including at least a portion of a hole or a slit through which the adhesive-layer-exposed portion is passed, wherein the first indicator portion, the first through portion, and the first wrapping portion are connected to each other in order of the first indicator portion, the first through portion, and the first wrapping portion in a first direction parallel with a surface of the mount sheet, wherein the second indicator portion, the second through portion, and the second wrapping portion are connected to each other in order of the second indicator portion, the second through portion, and the second wrapping portion in one of the first direction and a second direction opposite to the first direction, wherein at least one pair of (a) a pair of the first indicator portion and the second indicator portion, (b) a pair of the first through portion and the second through portion, or (c) a pair of the first wrapping portion and the second wrapping portion are connected to each other via a first line, wherein at least a portion of the first indicator portion and at least a portion of the second indicator portion are symmetric with respect to an imaginary line extending along the first line, wherein at least a portion of the first through portion and at least a portion of the second through portion are symmetric with respect to the imaginary line, wherein at least a portion of the first wrapping portion and at least a portion of the second wrapping portion are symmetric with respect to the imaginary line, wherein at least a portion of the hole or the slit of the first through portion and at least a portion of the hole or the slit of the second through portion are symmetric with respect to the imaginary line, and wherein the first wrapping portion, the first through portion, and the first indicator portion are arranged in order of the first wrapping portion, the first through portion, and the first indicator portion in a direction directed from one of opposite ends of the label medium, which one is connected to the spool, toward the other of the opposite ends of the label medium, and wherein the second wrapping portion, the second through portion, and the second indicator portion are arranged in order of the second wrapping portion, the second through portion, and the second indicator portion in the direction directed from the one of the opposite ends of the label medium toward the other of the opposite ends of the label medium.

Yet another aspect of the disclosure relates to a cassette containing a roll that is formed by winding a label medium around a spool, wherein the label medium includes: a mount sheet; and a label stuck to the mount sheet via an adhesive layer and including (i) a first indicator portion and a second indicator portion each including a region on which information is directly printable or writable and (ii) a first loop forming portion and a second loop forming portion for forming a loop, one of the first loop forming portion and the second loop forming portion including an adhesive-layer-exposed portion, wherein the first indicator portion and the first loop forming portion are connected to each other and arranged in order of the first indicator portion and the first loop forming portion in a first direction parallel with a surface of the mount sheet, wherein the second indicator portion and the second loop forming portion are connected to each other and arranged in order of the second indicator portion and the second loop forming portion in one of the first direction and a second direction opposite to the first direction, wherein at least one pair of (a) a pair of the first indicator portion and the second indicator portion or (b) a pair of the first loop forming portion and the second loop forming portion are connected to each other via a first line, wherein at least a portion of the first indicator portion and at least a portion of the second indicator portion are symmetric with respect to an imaginary line extending along the first line, wherein at least a portion of the first loop forming portion and at least a portion of the second loop forming portion are symmetric with respect to the imaginary line, wherein the first loop forming portion and the first indicator portion are arranged in order of the first loop forming portion and the first indicator portion in a direction directed from one of opposite ends of the label medium, which one is connected to the spool, toward the other of the opposite ends of the label medium, and wherein the second loop forming portion and the second indicator portion are arranged in order of the second loop forming portion and the second indicator portion in the direction directed from the one of the opposite ends of the label medium toward the other of the opposite ends of the label medium.

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIG. 1 is a perspective view of a printing apparatus;

FIG. 2 is a perspective view of the printing apparatus, with a cover opened;

FIG. 3 is a plan view of a protector partly cut out;

FIG. 4 is a plan view of a tape cassette, with an upper casing removed;

FIG. 5 is a view of a first label medium;

FIG. 6 is a view indicating a third length and a fourth length of holes;

FIG. 7 is a view indicating the third length and the fourth length of slits;

FIG. 8 is a view of a frame portion and a label stuck on a mount sheet;

FIG. 9 is a view of a back surface of the mount sheet, illustrating a slit or perforation;

FIGS. 10A through 10G are views for explaining a method of attaching the label to a wrapped member;

FIG. 11 is a view of a second label medium;

FIG. 12 is a view of a third label medium;

FIG. 13 is a view of a fourth label medium;

FIG. 14 is a view of a fifth label medium;

FIG. 15 is a view of a sixth label medium;

FIG. 16 is a view of a seventh label medium;

FIG. 17 is a view of another seventh label medium;

FIG. 18 is a view of an eighth label medium;

FIG. 19 is a view of a ninth label medium;

FIG. 20 is a view of a tenth label medium; and

FIGS. 21A through 21C are views of an eleventh label medium.

### DETAILED DESCRIPTION OF THE EMBODIMENTS

Hereinafter, there will be described embodiments by reference to the drawings. The drawings are for explanation of technical features employable in the present disclosure. It is to be understood that the configuration illustrated in the drawings does not limit the present disclosure and is only one example.

### Overall Configuration of Printing Apparatus

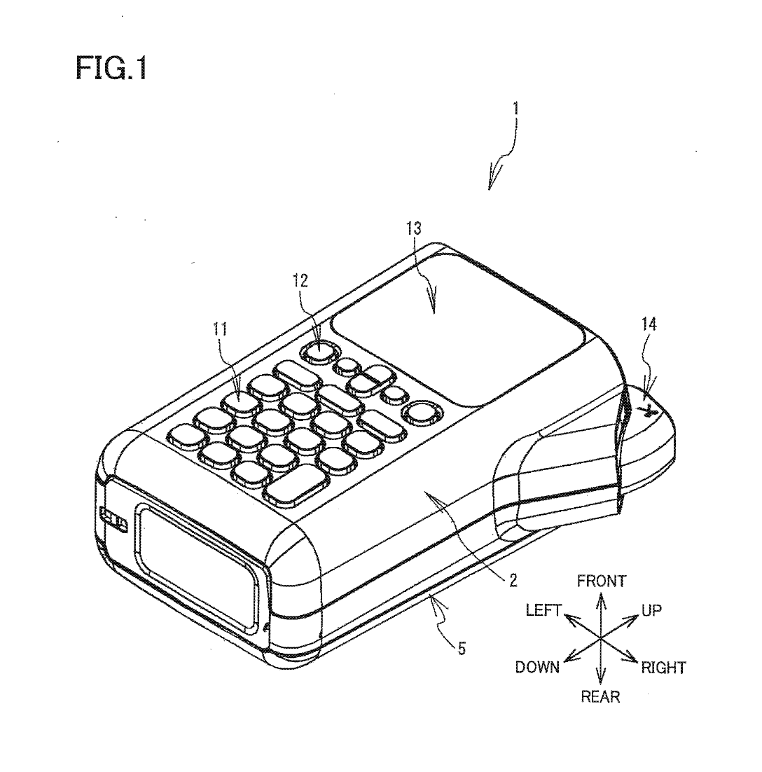

There will be described an overall configuration of a printing apparatus 1 with reference to FIGS. 1-3. The upper side, the lower side, the lower right side, the upper left side, the upper right side, and the lower left side in FIG. 1 are defined as an upper side, a lower side, a right side, a left side, a front side, and a rear side of the printing apparatus 1, respectively.

As illustrated in FIG. 1, the printing apparatus 1 has a substantially rectangular parallelepiped shape. The printing apparatus 1 includes a body housing 2 and a cover 5. The body housing 2 and the cover 5 are formed of resin. A keyboard 11 is provided on a lower portion of an upper surface of the body housing 2. The keyboard 11 is used for input of characters, for example. A function key group 12 is provided on an upper side of the keyboard 11. The function key group 12 is for turning a power source on and off and controlling print keys and the printing apparatus 1, for example. A liquid crystal display 13 is provided on an upper side of the function key group 12. The liquid crystal display 13 is configured to display characters and symbols input by a user, for example. The cover 5 is openably attached to a lower portion of the body housing 2.

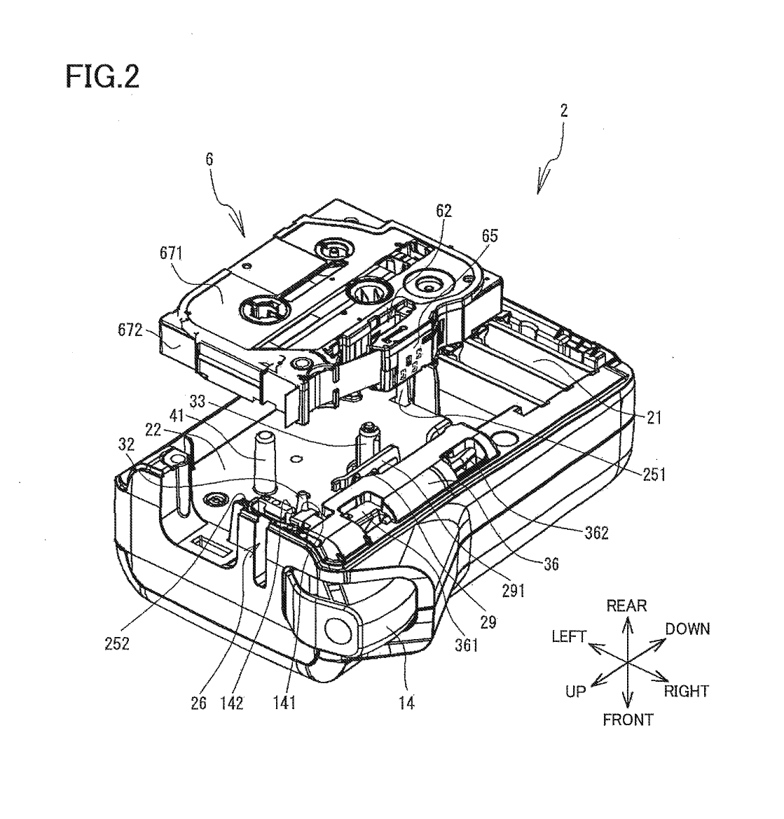

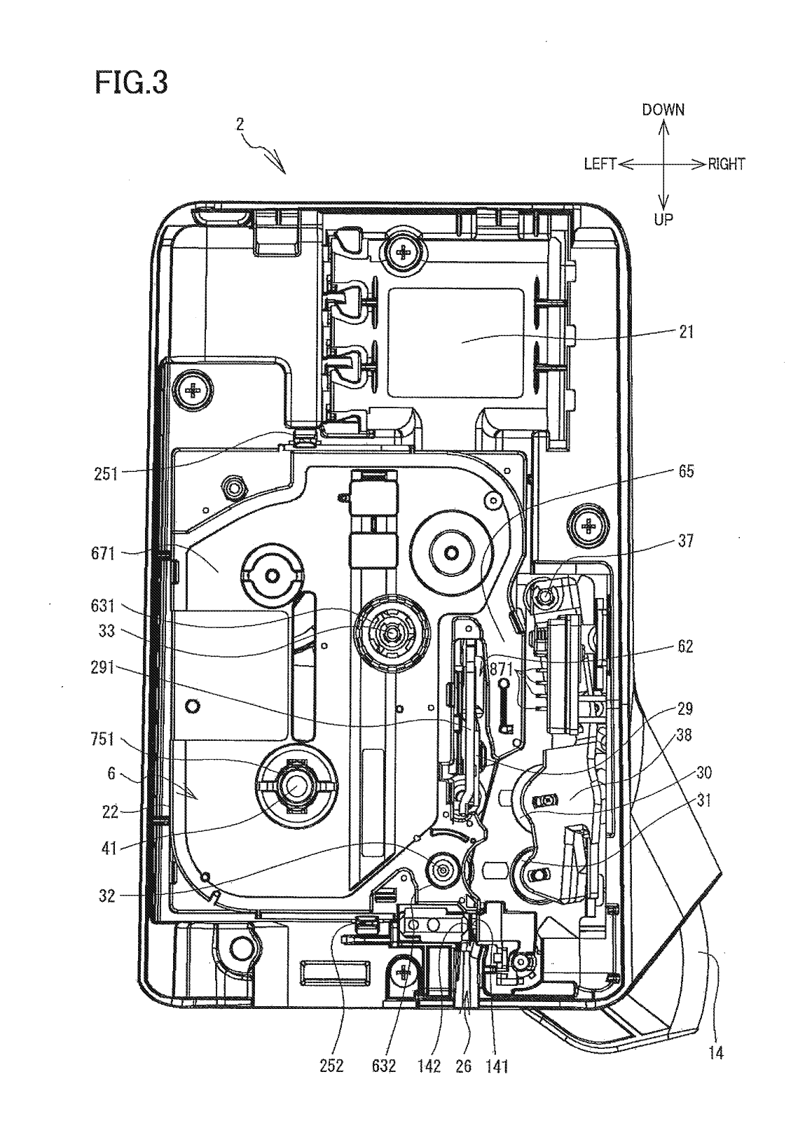

As illustrated in FIGS. 2 and 3, a battery holder 21 is provided at a lower right corner portion of the body housing 2. Three batteries are installable in and removable from the battery holder 21. A cassette holder 22 is provided on an upper side of the battery holder 21 so as be contiguous to the battery holder 21. A tape cassette 6 is installable in and removable from the cassette holder 22 through its rear portion. A hook 251 protrudes rearward from a lower end portion of the cassette holder 22. A hook 252 protrudes rearward from an upper end portion of the cassette holder 22. The hooks 251, 252 are engageable with the tape cassette 6 installed on the cassette holder 22.

An upper portion of the body housing 2 has a label output opening 26. A cutting knob 14 is provided on a corner portion located to the right of the label output opening 26. A movable blade 141 is provided in the label output opening 26. When pushed inwardly, the cutting knob 14 moves the movable blade 141 toward a fixed blade 142 to cut a printed tape. The printed tape cut by the fixed blade 142 and the movable blade 141 is discharged from the label output opening 26.

As illustrated in FIG. 3, the cassette holder 22 is provided with a thermal head 29, a platen roller 30, a tape sub-roller 31, a tape-driving-roller shaft 32, and a ribbon take-up shaft 33, for example. The platen roller 30 is provided to the right of the thermal head 29. The tape sub-roller 31 is provided near an upper portion of the platen roller 30. The tape-driving-roller shaft 32 is provided to the left of the tape sub-roller 31. The ribbon take-up shaft 33 is provided at a substantially center of the cassette holder 22.

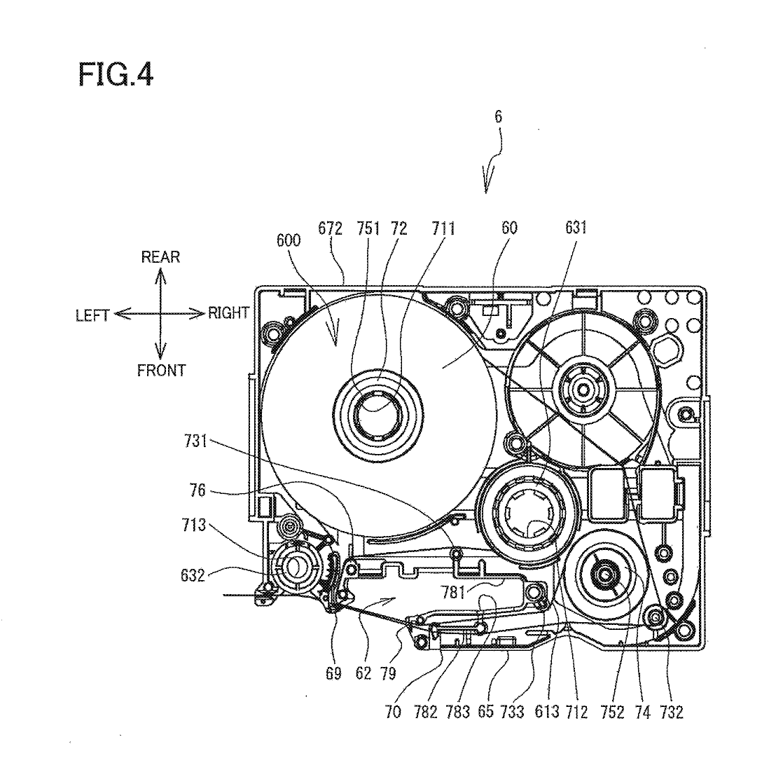

The thermal head 29 is provided on a surface of a head holder 291 which faces rightward. The head holder 291 is provided on the cassette holder 22 so as to be substantially orthogonal to a direction in which the label medium 60 (see FIG. 4) is conveyed in a head inserted portion 62 of the tape cassette 6.

The ribbon take-up shaft 33 is rotatably fitted in a ribbon take-up spool 631 provided on the tape cassette 6. The tape-driving-roller shaft 32 is rotatably fitted in a tape conveying roller 632 provided on the tape cassette 6. The ribbon take-up shaft 33 and the tape-driving-roller shaft 32 are rotated such that the label medium 60 and an ink ribbon 613 (see FIG. 4) are conveyed at the same speed.

As illustrated in FIG. 2, a protector 36 is provided at a right end portion of the body housing 2 which is located on an upper side of substantially the center of the body housing 2 in the up and down direction. The protector 36 is open toward the left side. The protector 36 has two through holes, namely, a cam guide hole 361 and a cam guide hole 362. On an upper side of the protector 36, a platen holder 38 illustrated in FIG. 3 is supported so as to be pivotable about a pivot shaft 37. The platen roller 30 and the tape sub-roller 31 are supported by the platen holder 38 so as to be rotatable in the counterclockwise direction in plan view. A spring, not illustrated, urges the platen holder 38 such that the platen holder 38 pivots rightward about the pivot shaft 37.

### Overall Configuration of Tape Cassette 6

There will be next explained an overall configuration of the tape cassette 6. In the following explanation, the lower side, the upper side, the right side, and the left side in FIG. 4, and the front surface and the back surface of the sheet of FIG. 4 are defined as a front side, a rear side, a right side, a left side, an upper side, and a lower side of the tape cassette 6, respectively.

As illustrated in FIG. 2, the tape cassette 6 is shaped like a box having a substantially rectangular shape in plan view. The tape cassette 6 includes an upper casing 671 (see FIG. 2) and a lower casing 672. As illustrated in FIG. 4, the tape cassette 6 has a support hole 711, a support hole 712, and a support hole 713. The support hole 711 supports a tape spool 72 such that the tape spool 72 is pivotable. The label medium 60 is rolled around the tape spool 72. The tape spool 72 holds a roll 600 formed by rolling the label medium 60. The support hole 712 supports the ribbon take-up spool 631. The ribbon take-up spool 631 takes up the ink ribbon 613 from a ribbon spool 74. The tape spool 72 and the ribbon spool 74 are rotatably fitted on a cassette boss 751 and a reel boss 752, respectively. The cassette boss 751 and the reel boss 752 are provided upright on a lower surface of the lower casing 672. The support hole 713 supports the tape conveying roller 632 such that the tape conveying roller 632 is rotatable. The tape conveying roller 632 and the tape sub-roller 31 (see FIG. 3) draw the label medium 60 from the roll 600 disposed around the tape spool 72.

An arm 65 protruding in an arm shape is provided on a front surface portion of the tape cassette 6. The head inserted portion 62 is formed by the arm 65 and a side wall 781 opposed to the arm 65 such that the head inserted portion 62 has a substantially U-shape in plan view. The head holder 291 (see FIG. 3) is inserted in the head inserted portion 62.

A pair of upper and lower guides 69 are provided near a front portion of the tape conveying roller 632. A ribbon separator 76 is provided near rear portions of the respective guides 69. A separation wall 782 shaped like a thin plate is provided at a central area between a front wall 70 of the arm 65 and a back wall 783 of the arm 65 which is nearer to the head inserted portion 62 than the front wall 70. An arm opening 79 is formed near a left end portion of the separation wall 782.

### Print Procedure

As illustrated in FIGS. 2, 3, and 4, the ribbon take-up shaft 33 and the tape-driving-roller shaft 32 are respectively fitted in the ribbon take-up spool 631 and the tape conveying roller 632 provided on the tape cassette 6, and the head holder 291 is inserted in the head inserted portion 62. A positioning boss 41 provided upright on a bottom surface portion of the cassette holder 22 is fitted in the cassette boss 751. As a result, the tape cassette 6 is pressed in a state in which the tape cassette 6 is positioned, whereby the tape cassette 6 is installed on the cassette holder 22. After the tape cassette 6 is installed on the cassette holder 22, the cover 5 is closed. In the case where the cover 5 is closed, a roller-holder cam, not illustrated, provided on the cover 5 is fitted in the cam guide hole 361. The roller-holder cam presses the platen holder 38 leftward. The platen holder 38 pivots leftward against an urging force of the spring, not illustrated.

The label medium 60 is conveyed from the tape spool 72 via a guide pin 732 through an area between the separation wall 782 and the front wall 70 of the arm 65. The ink ribbon 613 is conveyed from the ribbon spool 74 via a guide pin 733 through an area between the separation wall 782 and the back wall 783 of the arm 65. The ink ribbon 613 and the label medium 60 are arranged one on another and conveyed from the arm opening 79 to the head inserted portion 62. The label medium 60 and the ink ribbon 613 are then pressed onto the thermal head 29 by the platen roller 30. Heat generated by the thermal head 29 heats the ink ribbon 613 from an upper side thereof. As a result, ink is transferred to the label medium 60 by heat, so that information such as characters is printed on the label medium 60 based on print data. The ink ribbon 613 is separated from the label medium 60 by the ribbon separator 76. The separated ink ribbon 613 is conveyed through a guide pin 731 and taken up by the ribbon take-up spool 631. The printed tape from which the ink ribbon 613 is separated by the ribbon separator 76 is conveyed to the tape conveying roller 632 in a state in which upward and downward movement of the printed tape is restricted by the guides 69. The printed tape is then pressed by the tape sub-roller 31 onto the tape conveying roller 632 that is rotated by the tape-driving-roller shaft 32. The printed tape is discharged from the label output opening 26 by rotation of the tape conveying roller 632.

### First Label Medium 60

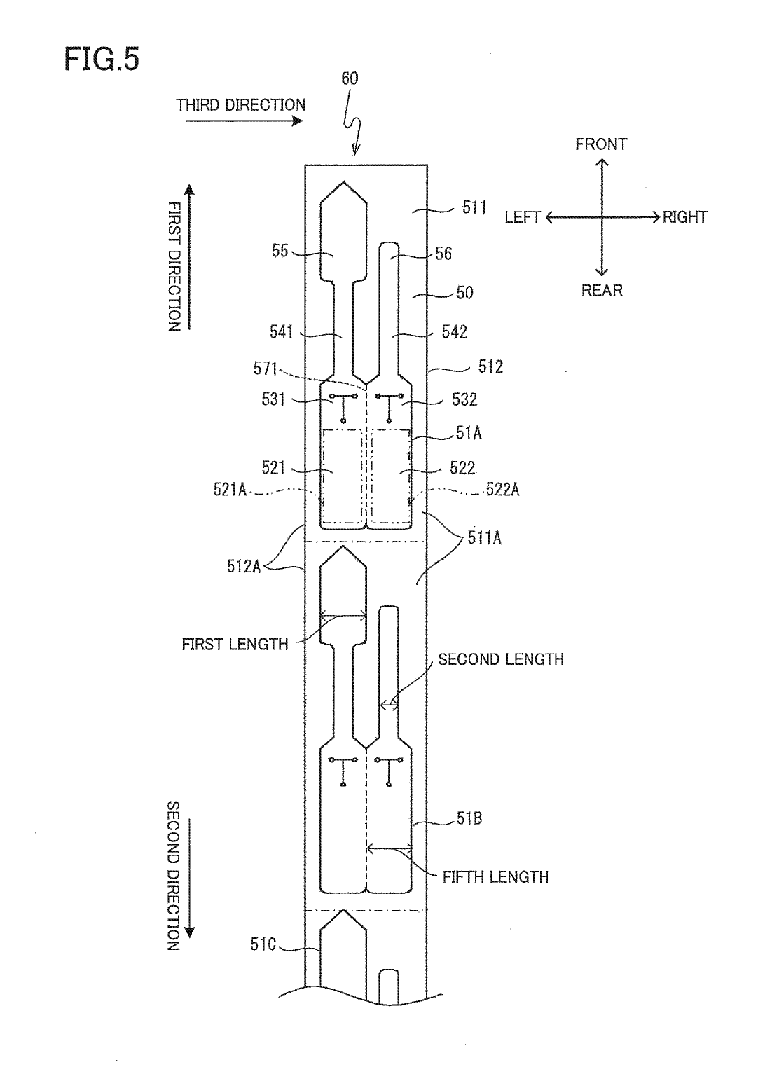

There will be next explained a first label medium 60 according to a first embodiment of the label medium 60 with reference to FIG. 5. There will be explained a case where information is to be printed on an indicator portion 52, which will be described below, by the printing apparatus 1 by way of example. However, information may be directly written on the indicator portion 52. The first label medium 60 includes a substrate 511 and a mount sheet 512 each having an elongated shape. The substrate 511 includes a plurality of partial substrates 511A connected to each other in an elongated direction (lengthwise direction) of the first label medium 60. Likewise, the mount sheet 512 includes a plurality of partial mount sheets 512A connected to each other in the elongated direction. Each of the partial substrates 511A and a corresponding one of the partial mount sheets 512A have the same shape and simultaneously cut by the fixed blade 142 and the movable blade 141 so as to be separated from the first label medium 60. Each of the partial substrates 511A includes: a corresponding one of labels 51A, 51B, 51C, and so on; and a corresponding one of frame portions 50A, 50B, 50C, and so on. The labels 51A, 51B, 51C, and so on will be hereinafter collectively referred to as “label 51”, and the frame portions 50A, 50B, 50C, and so on will be hereinafter collectively referred to as “frame portion 50”. That is, the labels 51A, 51B, 51C, and so on are arranged in the elongated direction of the first label medium 60. It is noted that since the printing apparatus 1 is capable of cutting the label medium 60 at any position, some cutting methods may create the cut label medium 60 including a plurality of the labels 51. The ink is transferred from the ink ribbon 613 to the label 51. The mount sheet 512 is release paper which is separated in use of the label 51. The substrate 511 and the mount sheet 512 are stacked on each other, with an adhesive layer interposed therebetween. The adhesive layer is provided on the substrate 511. The label 51 and the frame portion 50 are stuck to each partial mount sheets 512A by the adhesive layer. The front and rear direction in FIG. 5 corresponds to the elongated direction of the first label medium 60. A front end portion of the first label medium 60 in FIG. 5 is connected to the tape spool 72. The cut portion of the first label medium 60 (i.e., the partial substrate 511A and the partial mount sheet 512A) is printed by the printing apparatus 1 and then discharged through the label output opening 26 in order from a front end portion of the cut portion in FIG. 5.

One of the elongated direction and the widthwise direction of the mount sheet 512 will be hereinafter referred to as “first direction”. That is, in the example in FIG. 5, the labels 51 are arranged lengthwise on the label medium 60 such that the elongated direction of the label medium 60 and the elongated direction of each partial mount sheet 512A are parallel with each other, but the labels 51 may be arranged widthwise on the label medium 60 such that the elongated direction of the label medium 60 and the widthwise direction of each partial mount sheet 512A are parallel with each other. A direction opposite to the first direction is defined as “second direction”. The first direction and the second direction are parallel with each other. A direction orthogonal to the first direction and the second direction is defined as a third direction. In the present first embodiment, the first direction is one of opposite directions as the elongated direction of the label medium 60, which one is directed toward an end of the label medium 60 connected to the tape spool 72, and the partial mount sheets 512A are arranged lengthwise on the label medium 60. It is noted that, as illustrated in FIG. 5, the third direction is parallel with the widthwise direction of the mount sheet 512 and parallel with the widthwise direction of the label medium 60. In other words, the third direction is parallel with a surface (e.g., an upper surface) of the label medium 60 and perpendicular to the first direction.

As illustrated in FIG. 5, the label 51 includes a first indicator portion 521, a second indicator portion 522, a first through portion 531, a second through portion 532, a first wrapping portion 541, a second wrapping portion 542, an adhesive-layer-exposed portion 55, and a cover portion 56. In the case where these portions need not be distinguished from each other, the first indicator portion 521 and the second indicator portion 522 will be hereinafter collectively referred to as “indicator portion 52”, the first through portion 531 and the second through portion 532 as “through portion 53”, and the first wrapping portion 541 and the second wrapping portion 542 as “wrapping portion 54”.

The first indicator portion 521 and the second indicator portion 522 have the same shape and the same size. The first through portion 531 and the second through portion 532 have the same shape and the same size. The first wrapping portion 541 and the second wrapping portion 542 have the same shape and the same size. For example, as illustrated in FIG. 5, in the case where the adhesive-layer-exposed portion 55 and the cover portion 56 are connected to the first wrapping portion 541 and the second wrapping portion 542, respectively, the first indicator portion 521, the first through portion 531, the first wrapping portion 541, and the adhesive-layer-exposed portion 55 are arranged in this order in the first direction. That is, the first indicator portion 521, the first through portion 531, the first wrapping portion 541, and the adhesive-layer-exposed portion 55 are arranged in this order in a direction toward the end of the label medium 60 connected to the tape spool 72. The second indicator portion 522, the second through portion 532, the second wrapping portion 542, and the cover portion 56 are arranged in this order in the first direction. That is, the second indicator portion 522, the second through portion 532, the second wrapping portion 542, and the cover portion 56 are arranged in this order in the direction toward the end of the label medium 60 connected to the tape spool 72. It is noted that the first indicator portion 521 and the first through portion 531 at least need to be connected to (overlap) each other at least partially in the first direction, and the second indicator portion 522 and the first through portion 531 at least need to be connected to (overlap) each other at least partially in the first direction. Likewise, the first through portion 531 and the first wrapping portion 541 at least need to be connected to (overlap) each other at least partially in the first direction, and likewise the second through portion 532 and the second wrapping portion 542 at least need to be connected to (overlap) each other at least partially in the first direction. The first indicator portion 521 and the first through portion 531 need not be connected to (overlap) each other in the first direction, and the second indicator portion 522 and the first through portion 531 need not be connected to (overlap) each other in the first direction. Likewise, the first through portion 531 and the first wrapping portion 541 need not be connected to (overlap) each other in the first direction, and the second through portion 532 and the second wrapping portion 542 need not be connected to (overlap) each other in the first direction. The first indicator portion 521 and the first through portion 531 may be partly connected to each other in the third direction, and the second indicator portion 522 and the first through portion 531 may be partly connected to each other in the third direction. Likewise, the first through portion 531 and the first wrapping portion 541 may be partly connected to each other in the third direction, and the second through portion 532 and the second wrapping portion 542 may be partly connected to each other in the third direction. It is noted that, when viewed in the first direction, at least a portion of the first indicator portion 521 and at least a portion of the first through portion 531 overlap each other, at least a portion of the first through portion 531 and at least a portion of the first wrapping portion 541 overlap each other, or at least a portion of the first indicator portion 521, at least a portion of the first through portion 531, and at least a portion of the first wrapping portion 541 overlap each other. Likewise, when viewed in the first direction, at least a portion of the second indicator portion 522 and at least a portion of the second through portion 532 overlap each other, at least a portion of the second through portion 532 and at least a portion of the second wrapping portion 542 overlap each other, or at least a portion of the second indicator portion 522, at least a portion of the second through portion 532, and at least a portion of the first wrapping portion 541 overlap each other.

The indicator portion 52 has a substantially rectangular shape. The longitudinal direction of the indicator portion 52 coincides with the elongated direction of the first label medium 60. The first indicator portion 521 and the second indicator portion 522 are arranged in the third direction. In the present first embodiment, the first indicator portion 521 and the second indicator portion 522 are connected to each other at a first line 571. In the present first embodiment, the first line 571 extends parallel with the elongated direction of the first label medium 60. That is, the first line 571 is a line which is a portion of the substrate 511 and in which perforation that will be described below is formed, and the first line 571 is located between the first indicator portion 521 and the second indicator portion 522 and connects the first indicator portion 521 and the second indicator portion 522 to each other. The first line 571 has an elongated shape, and the elongated direction of the first line 571 is parallel with the elongated direction of the first label medium 60 and parallel with the first direction. The first line 571 includes the perforation formed in the substrate 511, and the elongated direction of the first line 571 and the direction in which the perforation extends are parallel with each other. The perforation formed at the first line 571 is located between the first indicator portion 521 and the second indicator portion 522. The direction in which the perforation extends is parallel with the elongated direction of the first label medium 60 and parallel with the first direction. The first indicator portion 521 and the second indicator portion 522 are symmetric with respect to the first line 571. That is, the first indicator portion 521 and the second indicator portion 522 are symmetric with respect to an imaginary line, which will be described below, extending through the first line 571 in the elongated direction of the first label medium 60. The imaginary line extends through the perforation formed at the first line 571. The imaginary line is an imaginary line which is located equidistant from the first indicator portion 521 and the second indicator portion 522 and which extends parallel with the elongated direction of the first label medium 60. The first line 571 also serves as a boundary line between the first indicator portion 521 and the second indicator portion 522. It is noted that the longest length of the indicator portion 52 in the third direction is a fifth length.

The indicator portion 52 has a printable region on which information is printed by the ink transferred from the ink ribbon 613. The printable region of the first indicator portion 521 will be hereinafter referred to as “first region 521A”. The printable region of the second indicator portion 522 will be hereinafter referred to as “second region 522A”.

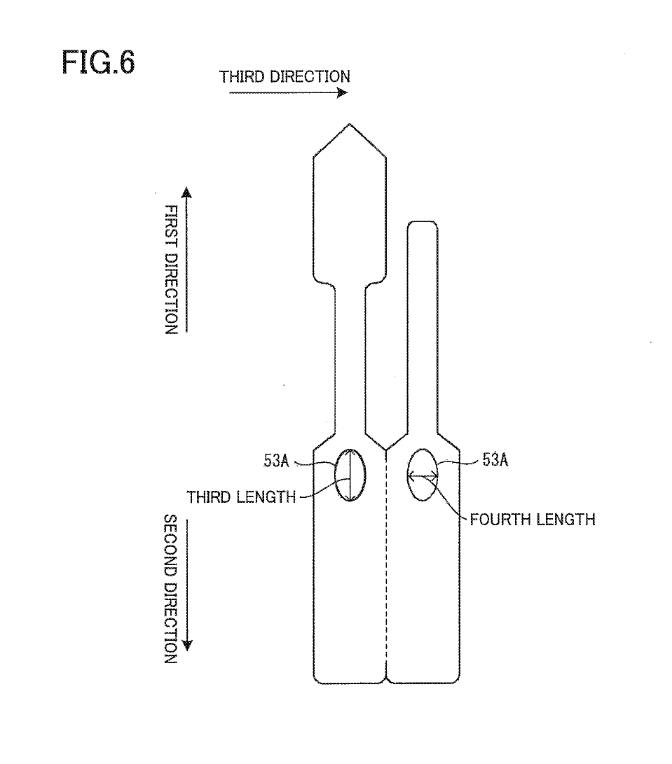

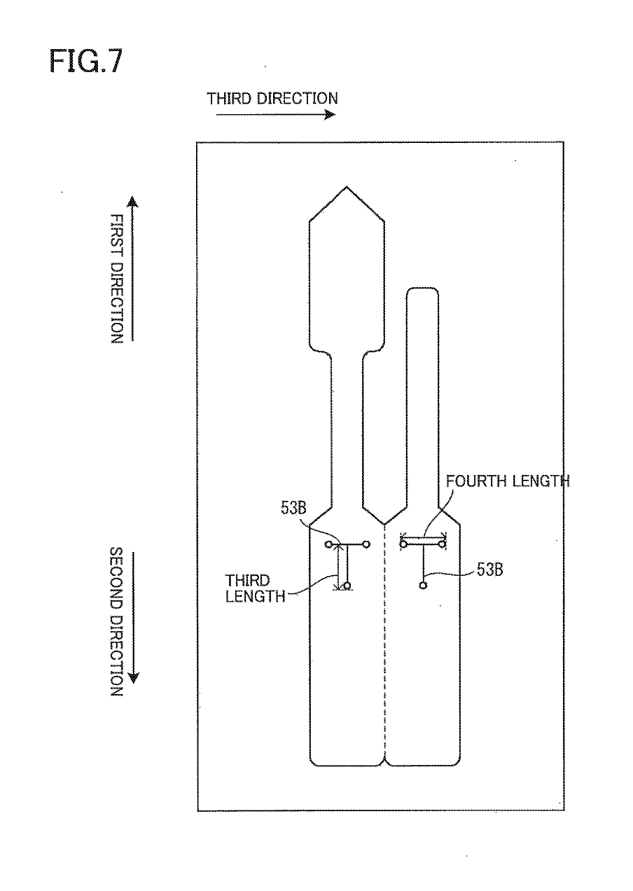

The through portion 53 is located between the indicator portion 52 and the wrapping portion 54. As illustrated in FIGS. 6 and 7, the through portion 53 has an oval hole 53A or a T-shaped slit 53B. The major axis of the hole 53A is parallel with the elongated direction, and the minor axis is parallel with the third direction. In the present first embodiment, the first through portion 531 and the second through portion 532 are connected to each other at the first line 571. The first through portion 531 and the second through portion 532 are symmetric with respect to the first line 571. An engaging portion 551 formed by the adhesive-layer-exposed portion 55 is passed through the hole 53A or the T-shaped slit 53B of the through portion, whereby the label 51 is held on a wrapped member 8. The longest length of the hole 53A or the T-shaped slit 53B in the first direction is a third length. The longest length of the hole 53A or the T-shaped slit 53B in the third direction is a fourth length. As illustrated in FIGS. 6 and 7, the third length is greater than the fourth length. In the case of the T-shaped slit 53B, the length of the slit in the first direction is the third length, and the length of the slit in the third direction is the fourth length. It is noted that the shape of the hole 53A is not limited to the oval shape but may be another shape such as a rectangular shape. The shape of the slit 53B is not limited to the T-shape but may be a cross shape. It is noted that, when viewed in the first direction, at least a portion of the first wrapping portion 541 and at least a portion of the hole 53A or the slit 53B of the first through portion 531 overlap each other, and when viewed in the first direction, at least a portion of the second wrapping portion 542 and at least a portion of the hole 53A or the slit 53B of the second through portion 532 overlap each other.

The wrapping portion 54 has a substantially rectangular shape. The first wrapping portion 541 and the second wrapping portion 542 are symmetric with respect to an imaginary line extended straight from the first line 571 in the elongated direction and in the first direction, i.e., a direction toward an end of the wrapping portion 54 which is not connected to the through portion 53. The longitudinal direction of the wrapping portion 54 coincides with the elongated direction of the first label medium 60. The longest length of the wrapping portion 54 in the third direction is a second length.

The adhesive-layer-exposed portion 55 is one of the wrapping portions 54. A distal end portion of the adhesive-layer-exposed portion 55 is tapered so as to be inclined with respect to the third direction. The length of the distal end portion in the third direction decreases with increase in distance from the first wrapping portion 541 in the first direction. That is, the distal end portion may not be tapered, and the length of the distal end portion at least needs to be less at its first-direction-side portion than at its second-direction-side portion. With this configuration, after the first indicator portion 521 and the second indicator portion 522 are stuck to each other, the first through portion 531 and the second through portion 532 are stuck to each other, the first wrapping portion 541 and the second wrapping portion 542 are stuck to each other, and the adhesive-layer-exposed portion 55 and the cover portion 56 are stuck to each other, the engaging portion 551 is easily formed by folding the adhesive-layer-exposed portion 55 a plurality of times from the distal end portion or rolling the adhesive-layer-exposed portion 55 from the distal end portion. As described above, the label 51 is held by the wrapped member 8 by passing the engaging portion 551 through the hole 53A or the T-shaped slit 53B of the through portion 53.

The cover portion 56 is connected to the other of the wrapping portions 54 which is not connected to the adhesive-layer-exposed portion 55. The cover portion 56 extends away from the through portion 53 connected to the wrapping portion 54 connected to the cover portion 56. When stuck to the adhesive-layer-exposed portion 55, the cover portion 56 covers a portion of the adhesive layer exposed from the adhesive-layer-exposed portion 55. That is, when stuck to the cover portion 56, the adhesive layer on the adhesive-layer-exposed portion 55 is partly exposed. The longest length of the adhesive-layer-exposed portion 55 in the third direction is a first length. In the example in FIG. 5, the adhesive-layer-exposed portion 55 and the cover portion 56 are connected to the first wrapping portion 541 and the second wrapping portion 542, respectively.

The first length of the adhesive-layer-exposed portion 55 is substantially equal to the third length of the hole 53A or the T-shaped slit 53B. This configuration makes it easy for the user to pass the engaging portion 551 through the hole 53A or the T-shaped slit 53B. The second length of the wrapping portion 54 is substantially equal to the fourth length of the hole 53A or the T-shaped slit 53B. With this configuration, in the case of the T-shaped slit 53B, for example, after the engaging portion 551 is passed through the hole 53A or the T-shaped slit 53B, the wrapping portion 54 is engaged with the slit extending in the third direction. Since the fourth length and the second length are substantially equal to each other, there is substantially no play in the hole 53A or the T-shaped slit 53B in the right and left direction. Thus, the indicator portion 52 can be kept easily viewable. Also, since there is substantially no play in the hole 53A or the T-shaped slit 53B in the right and left direction, it is possible improve the durability of the label 51. It is noted that the third length may be greater than or equal to the first length, and the fourth length may be greater than or equal to the second length. The first length at least needs to be less than or equal to the fifth length. It is noted that, in the present embodiment, as illustrated in FIG. 5, the first length that is the longest length of the adhesive-layer-exposed portion 55 in the third direction is greater than the second length that is the longest length of the wrapping portion 54 other than the adhesive-layer-exposed portion 55 in the third direction.

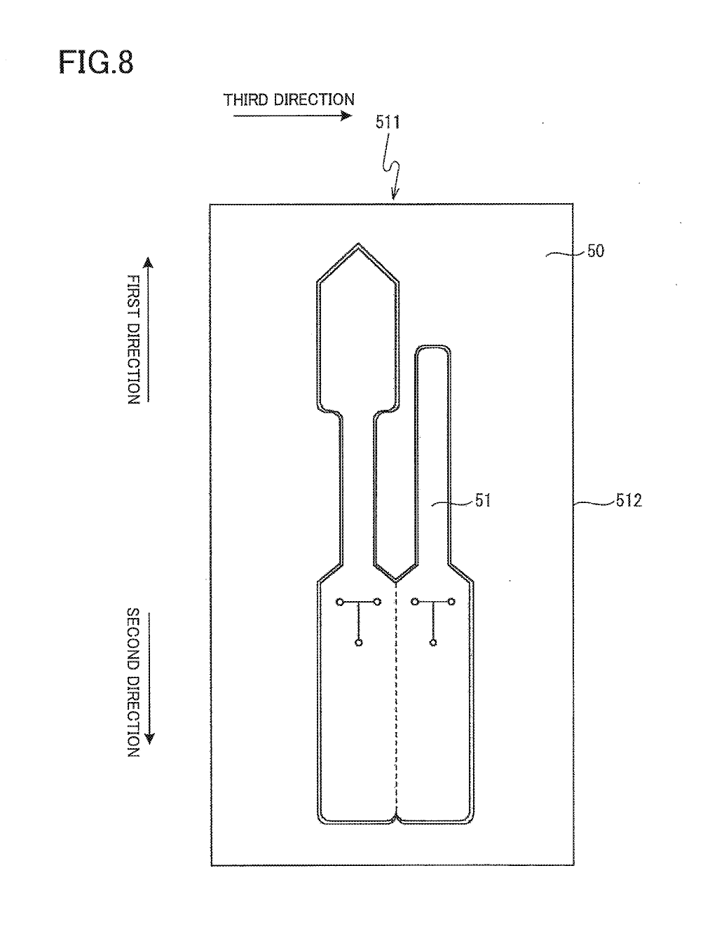

The frame portion 50 is the entire area of the substrate 511 except the labels 51. As illustrated in FIG. 8, slits are formed in the substrate 511 along boundaries between the frame portion 50 and each label 51. The user may detach the substrate 511 along the slits to peel off only the label 51 from the mount sheet 512. The frame portion 50 remains stuck to the mount sheet 512 in this operation. This reduces undesired peeling of the labels 51. Also, the frame portion 50 may be eliminated. That is, only the labels 51 may be bonded on the mount sheet 512. This configuration facilitates peeling off the label 51 from the mount sheet 512.

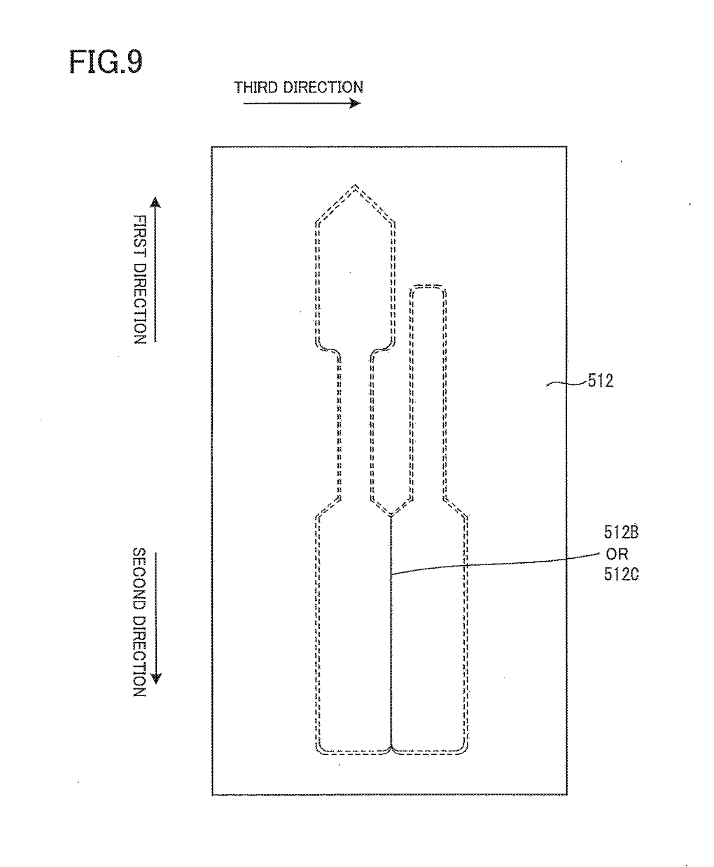

As illustrated in FIG. 9, the mount sheet 512 has a slit 512B or perforation 512C formed in the label 51 so as to be opposed to the first line 571. FIG. 9 illustrates the mount sheet 512 viewed from a back side thereof. The broken line in FIG. 9 is an imaginary line indicating the label 51 and the frame portion 50 stuck to a surface of the mount sheet 512, with the adhesive layer interposed between the mount sheet 512 and each of the label 51 and the frame portion 50. The solid line in FIG. 9 indicates the slit 512B or the perforation 512C. This configuration makes it easy for making mountain fold of the label 51 stuck to the mount sheet 512 at an appropriate position, resulting in reduced positional displacement when right and left portions of the label 51 peeled off from the mount sheet 512 are stuck to each other.

### Attachment of Label 51 to Wrapped Member 8

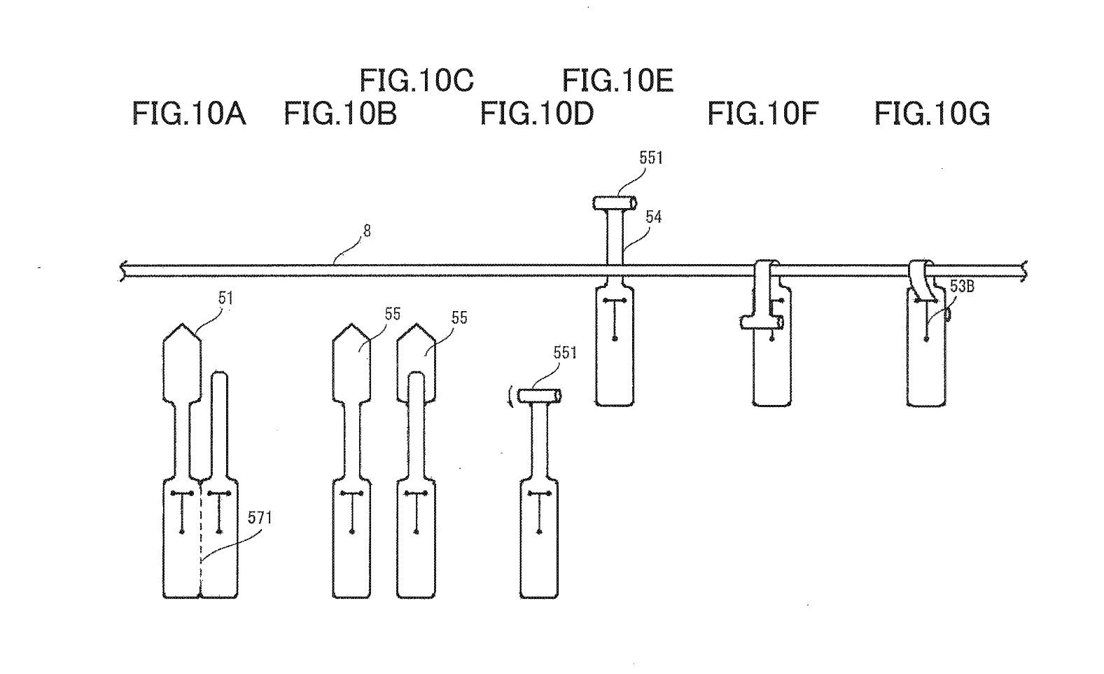

There will be next explained a procedure of attaching the label 51 to the wrapped member 8 such as a cable with reference to FIGS. 10A-10G. As illustrated in FIG. 10A, the label 51 is peeled off from the mount sheet 512. Mountain fold is made for the label 51 along the first line 571, and opposite-side portions of the label 51 are stuck to each other with respect to the first line 571. FIG. 10B illustrates the bent and stuck label 51 in a state in which the adhesive layer of the adhesive-layer-exposed portion 55 is located on a back side of the sheet of FIG. 10B. FIG. 10C illustrates the bent and stuck label 51 in a state in which the adhesive layer of the adhesive-layer-exposed portion 55 is located on a front side of the sheet of FIG. 10C. As illustrated in FIG. 10D, the adhesive-layer-exposed portion 55 is then rolled from its distal end to form the engaging portion 551. As illustrated in FIG. 10E, the wrapping portion 54 of the label 51 with the engaging portion 551 is brought into contact with the wrapped member 8. As illustrated in FIG. 10F, the wrapping portion 54 is then bent at a position at which the wrapping portion 54 is in contact with the wrapped member 8. As illustrated in FIG. 10G, the engaging portion 551 of the label 51 is then passed through the hole 53A or the T-shaped slit 53B of the through portion 53 to attach the label 51 to the wrapped member 8. In the examples in FIGS. 10A-10G, the through portion 53 has the T-shaped slit 53B.

### Second Label Medium 60

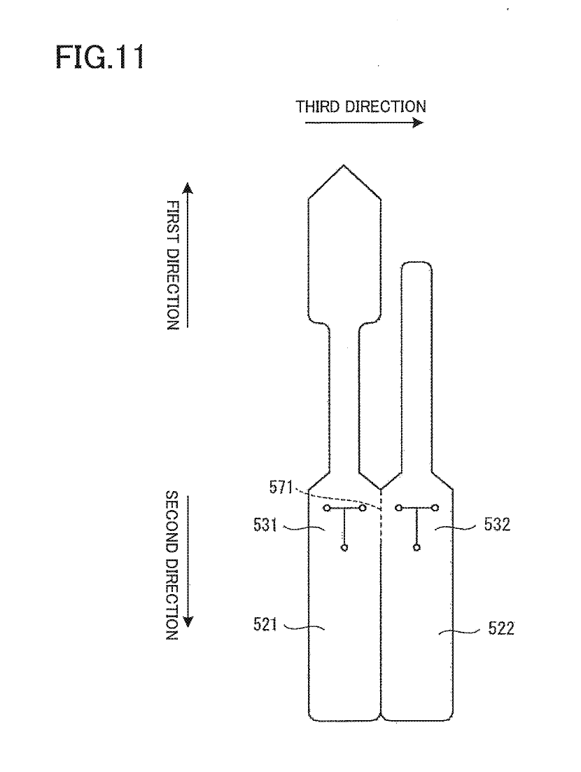

There will be next explained a second embodiment. In the first embodiment, the first line 571 connects between the first indicator portion 521 and the second indicator portion 522 and between the first through portion 531 and the second through portion 532. In the present second embodiment, as illustrated in FIG. 11, the first line 571 connects only between the first through portion 531 and the second through portion 532. The first indicator portion 521 and the second indicator portion 522 are symmetric with respect to an imaginary line obtained by extending the first line straight, and the first wrapping portion 541 and the second wrapping portion 542 are symmetric with respect to the imaginary line.

### Third Label Medium 60

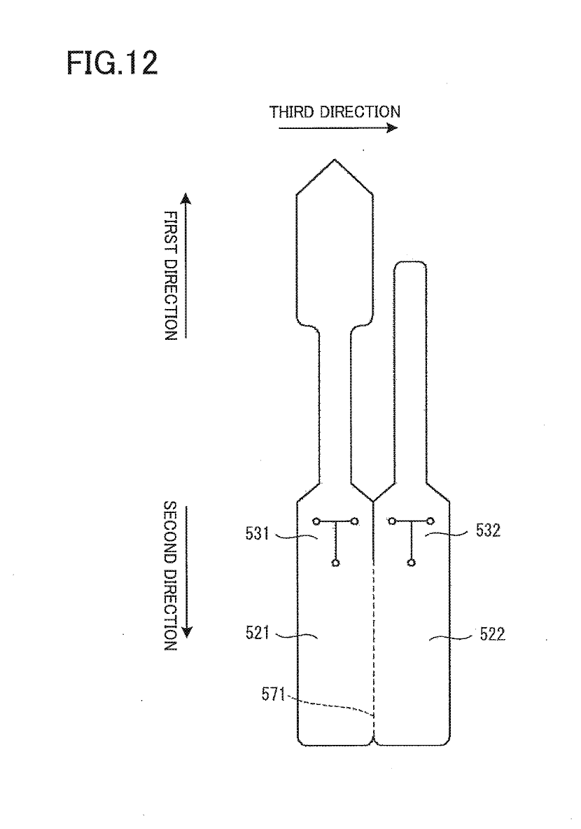

There will be next explained a third embodiment. In the first embodiment, the first line 571 connects between the first indicator portion 521 and the second indicator portion 522 and between the first through portion 531 and the second through portion 532. In the present third embodiment, as illustrated in FIG. 12, the first line 571 connects only between the first indicator portion 521 and the second indicator portion 522. The first through portion 531 and the second through portion 532 are symmetric with respect to an imaginary line obtained by extending the first line straight, and the first wrapping portion 541 and the second wrapping portion 542 are symmetric with respect to the imaginary line.

### Fourth Label Medium 60

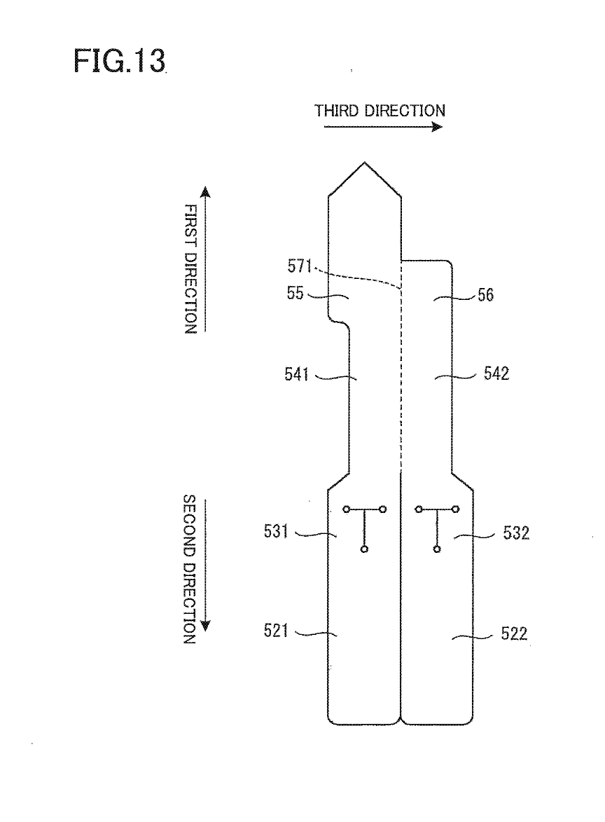

There will be next explained a fourth embodiment. In the first embodiment, the first line 571 connects between the first indicator portion 521 and the second indicator portion 522 and between the first through portion 531 and the second through portion 532. In the present fourth embodiment, as illustrated in FIG. 13, the first line 571 connects between the first wrapping portion 541 and the second wrapping portion 542 and between the adhesive-layer-exposed portion 55 and the cover portion 56. The first indicator portion 521 and the second indicator portion 522 are symmetric with respect to an imaginary line obtained by extending the first line straight, and the first through portion 531 and the second through portion 532 are symmetric with respect to the imaginary line. In the present fourth embodiment, the first line 571 may be formed so as to connect between the first wrapping portion 541 and the second wrapping portion 542 and between the first through portion 531 and the second through portion 532. The first line 571 may be formed so as to connect between the first wrapping portion 541 and the second wrapping portion 542, between the first through portion 531 and the second through portion 532, and between the first indicator portion 521 and the second indicator portion 522. The first line 571 may be formed so as to connect only between the first wrapping portion 541 and the second wrapping portion 542. The first line 571 may be formed so as to connect only between the adhesive-layer-exposed portion 55 and the cover portion 56.

### Fifth Label Medium 60

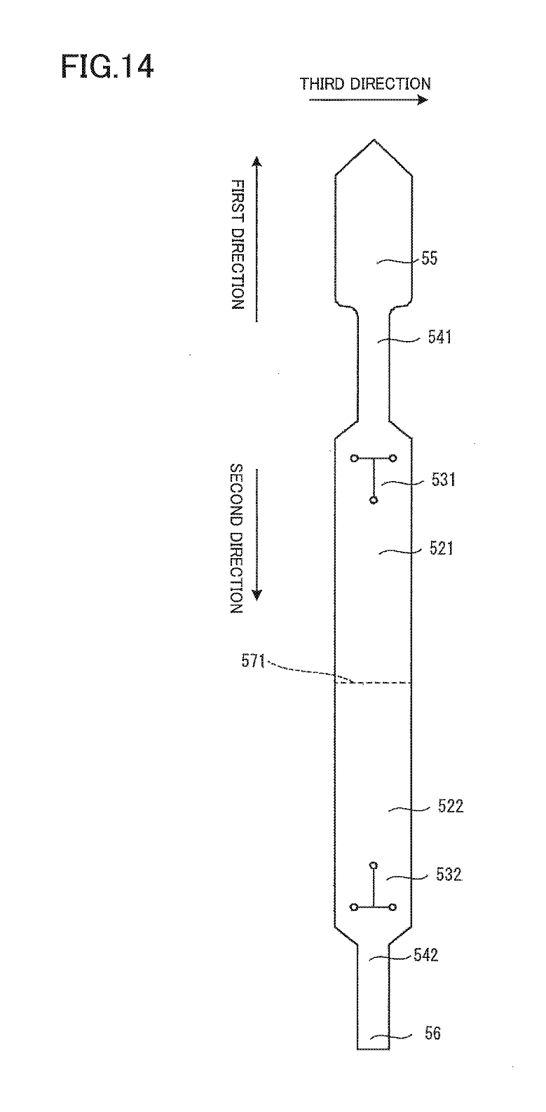

There will be next explained a fifth embodiment. In the first embodiment, the first line 571 is parallel with the elongated direction. In the present fifth embodiment, as illustrated in FIG. 14, the first line 571 is parallel with the third direction. In the case where it is assumed that the first indicator portion 521 is located on a first-direction-side of the first line 571, the first line 571 connects between a second-direction-side end portion of the first indicator portion 521 and a first-direction-side end portion of the second indicator portion 522. Like the first line 571 in FIG. 5, the first line 571 in the present embodiment is a line which is a portion of the substrate 511 and in which perforation is formed, and the first line 571 is located between the first indicator portion 521 and the second indicator portion 522 and connects the first indicator portion 521 and the second indicator portion 522 to each other. The first line 571 in the present embodiment has an elongated shape, and the elongated direction of the first line 571 is parallel with the widthwise direction of the fifth label medium 60 and parallel with the third direction. That is, the direction in which the first line 571 extends is perpendicular to the elongated direction of the fifth label medium 60 and perpendicular to the first direction. The first indicator portion 521 and the second indicator portion 522 are symmetric with respect to the first line 571. That is, the first indicator portion 521 and the second indicator portion 522 are symmetric with respect to an imaginary line extending through the first line 571 in the widthwise direction of the first label medium 60. The imaginary line extends through the perforation formed at the first line 571. The imaginary line is an imaginary line which is located equidistant from the first indicator portion 521 and the second indicator portion 522 and which extends parallel with the widthwise direction of the first label medium 60. In the present fifth embodiment, the first indicator portion 521, the first through portion 531, the first wrapping portion 541, and the adhesive-layer-exposed portion 55 are arranged in this order in the first direction. The second indicator portion 522, the second through portion 532, the second wrapping portion 542, and the cover portion 56 are arranged in this order in the second direction opposed to the first direction. The example in FIG. 14 is an example in which the adhesive-layer-exposed portion 55 is connected to the first wrapping portion 541. The adhesive-layer-exposed portion 55 may be connected to the second wrapping portion 542. In the present fifth embodiment, the indicator portions 52 are not arranged in the third direction unlike the first to fourth embodiments. Thus, the length (the fifth length) of each of the first indicator portion 521 and the second indicator portion 522 in the third direction in the present fifth embodiment may be greater than the length (the fifth length) of each of the first indicator portion 521 and the second indicator portion 522 in the third direction in the first to fourth embodiments. Accordingly, a larger amount of information may be printed or directly written on the indicator portion.

### Sixth Label Medium 60

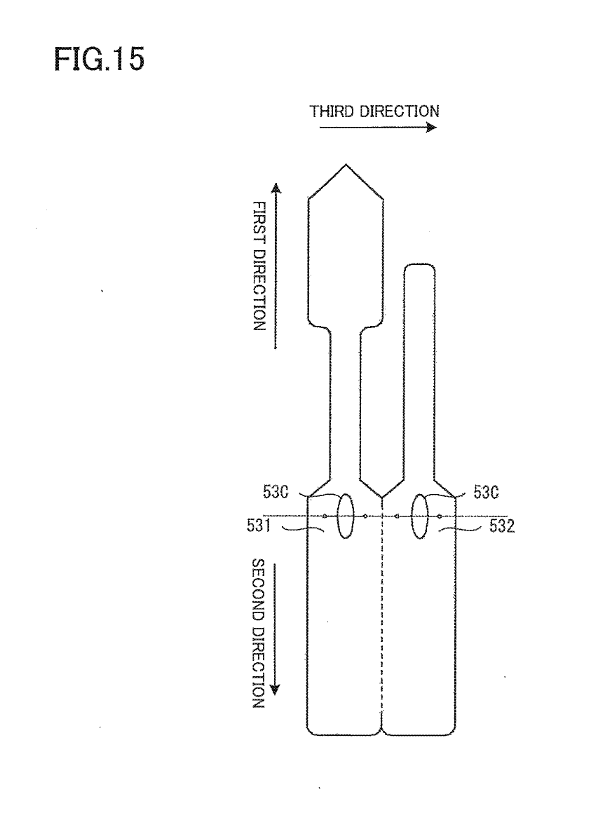

There will be next explained a sixth embodiment. In the first embodiment, the through portion 53 has the hole 53A or the T-shaped slit 53B. In the present sixth embodiment, as illustrated in FIG. 15, the through portion 53 has a through hole 53C formed by combining a hole and a slit with each other. As illustrated in FIG. 15, the through hole 53C includes: an oval whose major axis is parallel with the elongated direction (i.e., the first direction and the second direction); and two slits extending outward from the periphery of the oval. Each of the two slits extends straight and is parallel with the third direction. The broken line in FIG. 15 which extends in a straight line parallel with the third direction is an imaginary line indicating that the two slits are on a straight line. It is noted that the through portion 53 may be formed such that the major axis of the oval is parallel with the third direction, and each of the slits is parallel with the elongated direction.

### Seventh Label Medium 60

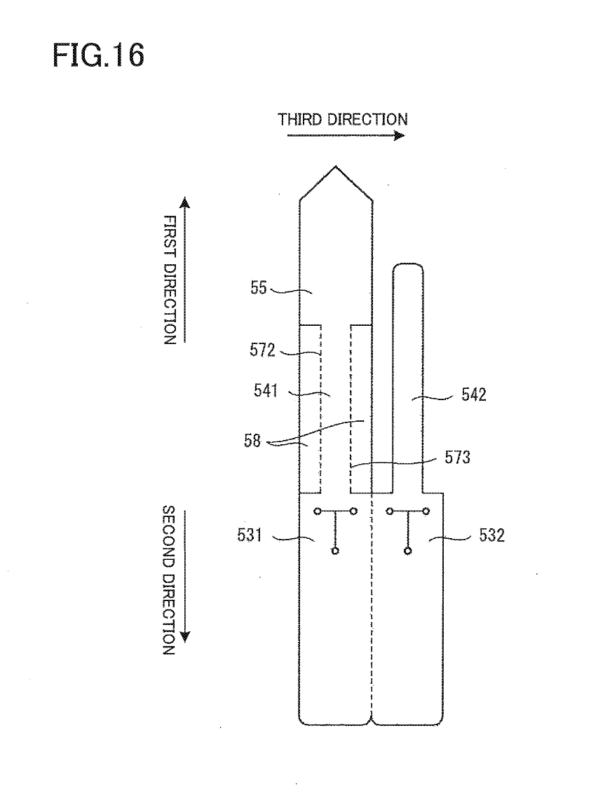

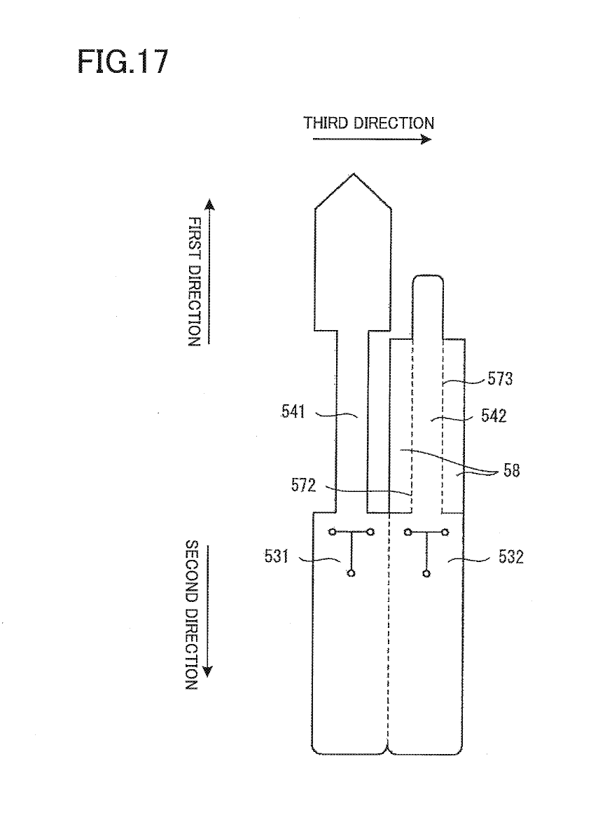

There will be next explained a seventh embodiment. In the present seventh embodiment, the label 51 has reinforcing portions 58. After the wrapping portions 54 are stuck to each other, the reinforcing portions 58 are stuck onto the wrapping portion 54 and thereby reinforce the reinforcing portions 58. This configuration improves the durability of the label 51. In the present seventh embodiment, as illustrated in FIGS. 16 and 17, the reinforcing portions 58 are respectively provided on opposite edges of one of the wrapping portions 54 in the third direction. The left reinforcing portion 58 in FIGS. 16 and 17 and the wrapping portion 54 are connected to each other at a second line 572, and the right reinforcing portion 58 in FIGS. 16 and 17 and the wrapping portion 54 are connected to each other at a third line 573. In the example in FIG. 16, the reinforcing portions 58 are not connected to the through portion 53 and are not connected to the adhesive-layer-exposed portion 55. In the example in FIG. 17, the reinforcing portions 58 are not connected to the through portion 53. It is noted that the length of each of the reinforcing portions 58 in the elongated direction at least needs to be less than or equal to the length of the wrapping portion 54 in the elongated direction. The reinforcing portions 58 may be provided at any positions on opposite sides of the wrapping portion 54 in the third direction.

### Eighth Label Medium 60

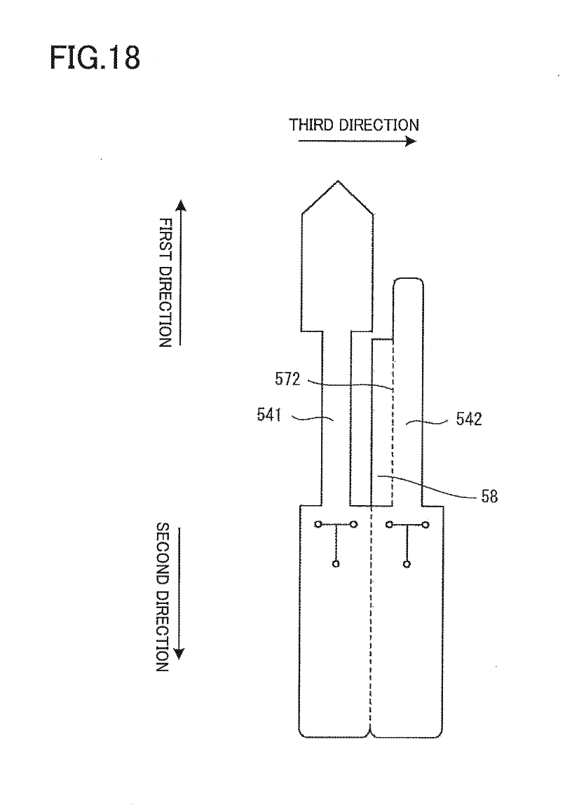

There will be next explained an eighth embodiment. In the present eighth embodiment, as illustrated in FIG. 18, the reinforcing portion 58 is provided on one of opposite edges of one of the wrapping portions 54 in the third direction. In the example in FIG. 18, the wrapping portion 54 and the reinforcing portions 58 are connected to each other at the second line 572. It is noted that the reinforcing portions 58 may be connected at the second line 572 or the third line 573 to one of opposite edges of one of the wrapping portions 54 in the third direction.

### Ninth Label Medium 60

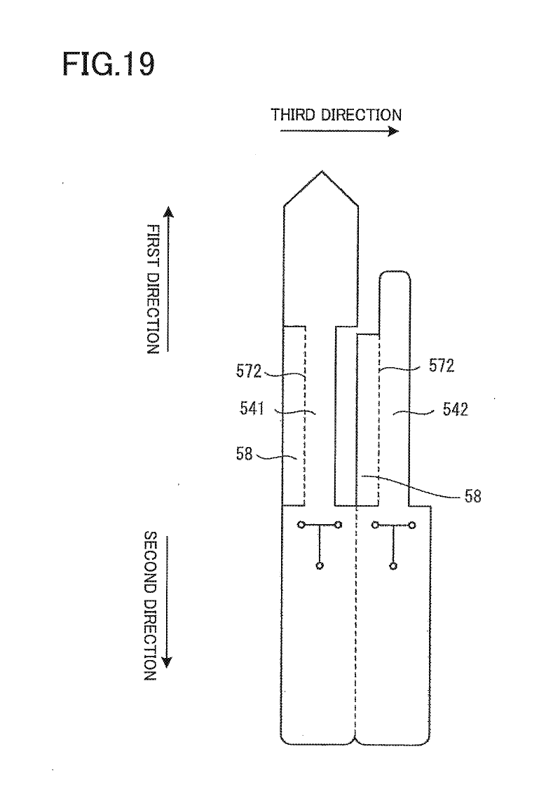

There will be next explained a ninth embodiment. In the present ninth embodiment, as illustrated in FIG. 19, the reinforcing portions 58 are respectively provided on one of opposite edges of one of the wrapping portions 54 and one of opposite edges of the other of the wrapping portions 54 in the third direction. In the example in FIG. 19, each of the wrapping portions 54 and a corresponding one of the reinforcing portions 58 are connected to each other at the second line 572. It is noted that each of the wrapping portions 54 and a corresponding one of the reinforcing portions 58 are connected to each other at the third line 573.

### Tenth Label Medium 60

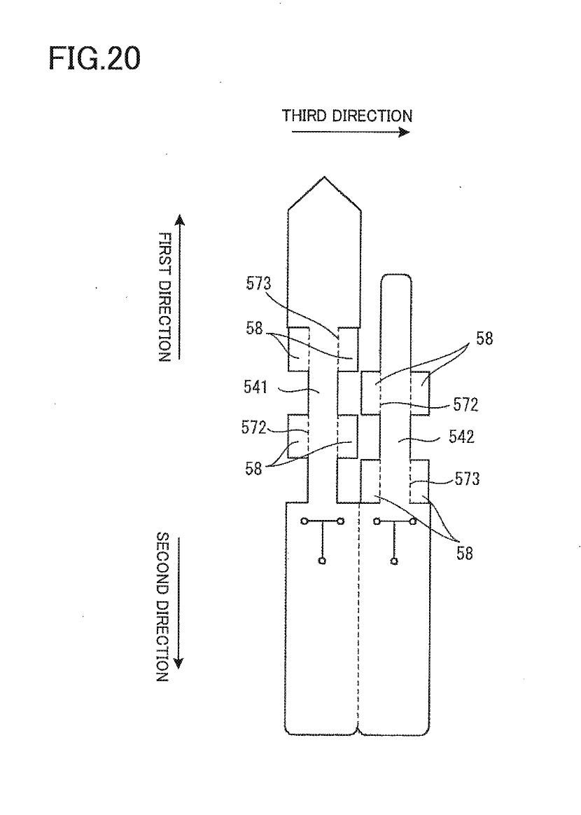

There will be next explained a tenth embodiment. In the present tenth embodiment, the reinforcing portions 58 are connected to each of at least one of opposite edges of at least one of the wrapping portions 54 in the third direction at a corresponding one of the second line 572 and the third line 573. In the example in FIG. 20, the reinforcing portions 58 are connected to each of the opposite edges of both of the wrapping portions 54 in the third direction at a corresponding one of the second line 572 and the third line 573.

### Eleventh Label Medium 60

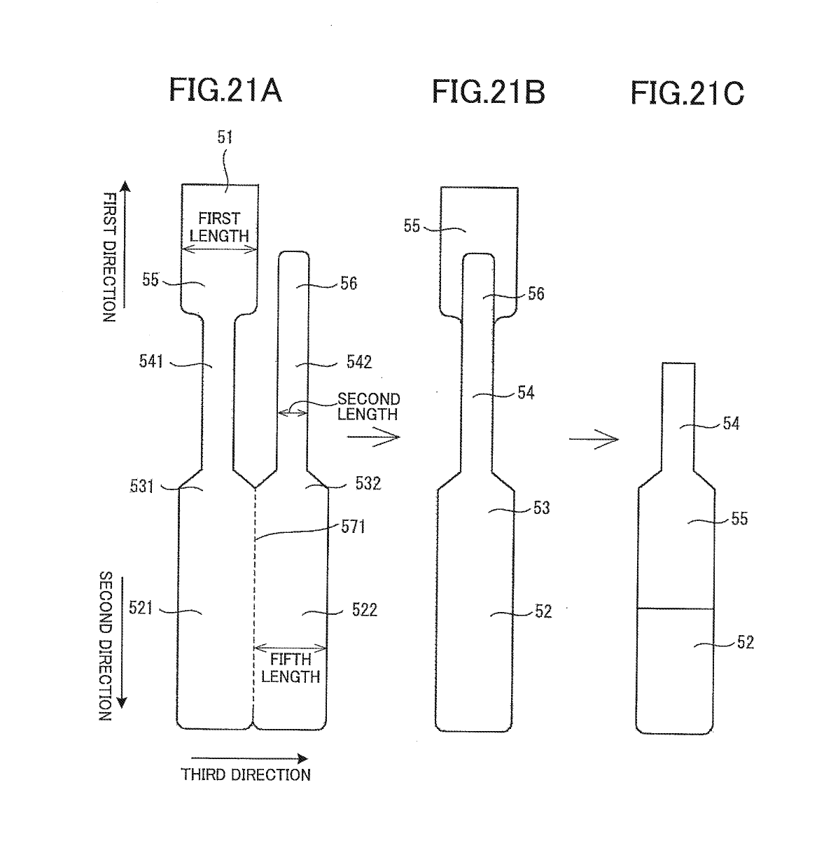

There will be next explained an eleventh embodiment. The label 51 has the through portions 53 in the first to tenth embodiments. In the present eleventh embodiment, the label 51 does not have the through portions 53. In the present eleventh embodiment, the first through portion 531 and the second through portion 532 are respectively referred to as “first sticking portion 531” and “second sticking portion 532”. The through portion 53 is referred to as “sticking portion 53”. The sticking portion 53 is a portion of the indicator portion 52. That is, since holes or slits such as the hole 53A and the T-shaped slit 53B are not formed, the engaging portion 551 cannot be passed through the sticking portion 53. In the present eleventh embodiment, a loop is formed by sticking the adhesive-layer-exposed portion 55 to the sticking portion 53 or a loop forming portion 54 which will be described below. Thus, in the present eleventh embodiment, the first wrapping portion 541 is referred to as “first loop forming portion 541”, and the second wrapping portion 542 is referred to as “second loop forming portion 542”. The wrapping portion 54 is referred to as “loop forming portion 54”. In the present eleventh embodiment, as illustrated in FIGS. 21A-21C, a distal end portion of the adhesive-layer-exposed portion 55 is not tapered. This increases the size of the indicator portion 52. It is noted that, as illustrated in FIG. 21, when viewed in the first direction, a portion of the first loop forming portion 541 and a portion of the first indicator portion 521 overlap each other. When viewed in the first direction, a portion of the second loop forming portion 542 and a portion of the second indicator portion 522 overlap each other. In the present embodiment, the first loop forming portion 541 and the second loop forming portion 542 have the same shape and the same size. The first indicator portion 521 and the second indicator portion 522 have the same shape and the same size. The first sticking portion 531 and the second sticking portion 532 have the same shape and the same size. In the present embodiment, two reinforcing portions 58 as illustrated in FIG. 16 or 17 may be respectively connected to opposite edges of the first wrapping portion 541 or the second wrapping portion 542 in the third direction via the second line 572 and the third line 573. That is, the label 51 has at least one reinforcing portion 58 for reinforcing the loop forming portion 54 formed by sticking the first loop forming portion 541 and the second loop forming portion 542 to each other, the at least one reinforcing portion 58 may be connected at the second line 572 and/or the third line 573 to one or both of opposite edges of at least one of the first loop forming portion 541 and the second loop forming portion 542 in the third direction.

In the present eleventh embodiment, as in the first embodiment, the frame portion 50 may or may not be provided. The techniques in the second to fifth embodiments and the seventh to tenth embodiments may be incorporated into the present eleventh embodiment. The first length of the adhesive-layer-exposed portion 55 may be less than or equal to the second length of the loop forming portion 54 and may be less than or equal to the fifth length of the indicator portion 52. With this configuration, when forming the loop through which the indicator portion 52 is to be passed, the adhesive-layer-exposed portion 55 does not protrude from a portion of the label 51 to which the adhesive-layer-exposed portion 55 is to be stuck (i.e., the sticking portion 53 or the loop forming portion 54), because the first length (width) of the adhesive-layer-exposed portion 55 is less than or equal to the second length (width) or the fifth length (width) of the portion to which the adhesive-layer-exposed portion 55 is to be stuck. This prevents the adhesive-layer-exposed portion 55 from being bonded to the wrapped member 8, making it easy to change the position of the label 51 and remove the label 51, for example.

Here, there will be explained a method of attaching the label 51 to the wrapped member 8 with reference to FIGS. 21A-21C. The label 51 is first peeled off from the mount sheet 512. FIG. 21A illustrates a state in which the label 51 is peeled off from the mount sheet 512. As illustrated in FIG. 21B, mountain fold is then made for the first line 571, and opposite-side portions of the label 51 are stuck to each other with respect to the first line 571. As illustrated in FIG. 21C, the adhesive-layer-exposed portion 55 is then stuck to the sticking portion 53, whereby the loop forming portion 54 forms a loop through which the indicator portion 52 is to be passed. As described above, the indicator portion 52 is passed through the loop formed by sticking the adhesive-layer-exposed portion 55 to the sticking portion 53, whereby the label 51 is attached to the wrapped member.

What is claimed is:

1. A label medium, comprising:
a mount sheet; and
a label stuck to the mount sheet via an adhesive layer and comprising (i) a first indicator portion and a second indicator portion each comprising a region on which information is directly printable or writable, (ii) a first wrapping portion and a second wrapping portion to be wrapped on a wrapped member, one of the first wrapping portion and the second wrapping portion comprising an adhesive-layer-exposed portion, and (iii) a first through portion and a second through portion each comprising at least a portion of a hole or a slit through which the adhesive-layer-exposed portion is passed,
wherein the first indicator portion, the first through portion, and the first wrapping portion are connected to each other in order of the first indicator portion, the first through portion, and the first wrapping portion in a first direction parallel with a surface of the mount sheet,
wherein the second indicator portion, the second through portion, and the second wrapping portion are connected to each other in order of the second indicator portion, the second through portion, and the second wrapping portion in one of the first direction and a second direction opposite to the first direction,
wherein at least one pair of (a) a pair of the first indicator portion and the second indicator portion, (b) a pair of the first through portion and the second through portion, or (c) a pair of the first wrapping portion and the second wrapping portion are connected to each other via a first line,
wherein at least a portion of the first indicator portion and at least a portion of the second indicator portion are symmetric with respect to an imaginary line extending along the first line,
wherein at least a portion of the first through portion and at least a portion of the second through portion are symmetric with respect to the imaginary line,
wherein at least a portion of the first wrapping portion and at least a portion of the second wrapping portion are symmetric with respect to the imaginary line, and
wherein at least a portion of the hole or the slit of the first through portion and at least a portion of the hole or the slit of the second through portion are symmetric with respect to the imaginary line.

2. The label medium according to claim 1,
wherein, when viewed in the first direction, (a) at least a portion of the first indicator portion and at least a portion of the first through portion, (b) at least a portion of the first through portion and at least a portion of the first wrapping portion, or (c) at least a portion of the first indicator portion, at least a portion of the first through portion, and at least a portion of the first wrapping portion overlap each other, and
wherein when viewed in the first direction, (a) at least a portion of the second indicator portion and at least a portion of the second through portion, (b) at least a portion of the second through portion and at least a portion of the second wrapping portion, or (c) at least a portion of the second indicator portion, at least a portion of the second through portion, and at least a portion of the second wrapping portion overlap each other.

3. The label medium according to claim 1,
wherein when viewed in the first direction, at least a portion of the first wrapping portion and at least a portion of the hole or the slit of the first through portion overlap each other, and
wherein when viewed in the first direction, at least a portion of the second wrapping portion and at least a portion of the hole or the slit of the second through portion overlap each other.

4. The label medium according to claim 1, wherein a first length that is a longest length of the adhesive-layer-exposed portion in a third direction orthogonal to the first direction is greater than a second length that is a longest length of the first wrapping portion and the second wrapping portion except the adhesive-layer-exposed portion in the third direction.

5. The label medium according to claim 4, wherein a third length that is a longest length of the hole or the slit in the first direction is greater than or equal to the first length.

6. The label medium according to claim 4, wherein a fourth length that is a longest length of the hole or the slit in the third direction is greater than or equal to the second length.

7. The label medium according to claim 4, wherein the first length is equal to the third length that is a longest length of the hole or the slit in the first direction.

8. The label medium according to claim 4, wherein the second length is equal to a fourth length that is a longest length of the hole or the slit in the third direction.

9. The label medium according to claim 1, wherein the label comprises a cover portion that covers a portion of the adhesive-layer-exposed portion and that extends in a direction directed, from one of opposite ends of one of the first through portion and the second through portion which is connected to the other of the first wrapping portion and the second wrapping portion which does not comprise the adhesive-layer-exposed portion, toward the other of the opposite ends of the one of the first through portion and the second through portion.

10. The label medium according to claim 1, wherein the adhesive-layer-exposed portion is tapered toward a distal end portion of the adhesive-layer-exposed portion.

11. The label medium according to claim 1, wherein the first through portion and the second through portion are connected to each other via the first line.

12. A label medium, comprising:
a mount sheet; and
a label stuck to the mount sheet via an adhesive layer and comprising (i) a first indicator portion and a second indicator portion each comprising a region on which information is directly printable or writable and (ii) a first loop forming portion and a second loop forming portion for forming a loop, one of the first loop forming portion and the second loop forming portion comprising an adhesive-layer-exposed portion,
wherein the first indicator portion and the first loop forming portion are connected to each other and arranged in order of the first indicator portion and the first loop forming portion in a first direction parallel with a surface of the mount sheet,
wherein the second indicator portion and the second loop forming portion are connected to each other and arranged in order of the second indicator portion and the second loop forming portion in one of the first direction and a second direction opposite to the first direction,
wherein at least one pair of (a) a pair of the first indicator portion and the second indicator portion or (b) a pair of the first loop forming portion and the second loop forming portion are connected to each other via a first line,
wherein at least a portion of the first indicator portion and at least a portion of the second indicator portion are symmetric with respect to an imaginary line extending along the first line, and
wherein at least a portion of the first loop forming portion and at least a portion of the second loop forming portion are symmetric with respect to the imaginary line.

13. The label medium according to claim 12,
wherein when viewed in the first direction, at least a portion of the first indicator portion and at least a portion of the first loop forming portion overlap each other, and
wherein when viewed in the first direction, at least a portion of the second indicator portion and at least a portion of the second loop forming portion overlap each other.

14. The label medium according to claim 12, wherein at least a pair of (a) the pair of the first indicator portion and the second indicator portion or (b) the pair of the first loop forming portion and the second loop forming portion have an identical shape and an identical size.

15. The label medium according to claim 12, wherein a first length that is a longest length of the adhesive-layer-exposed portion in a third direction orthogonal to the first direction is less than or equal to a second length that is a longest length of the first loop forming portion and the second loop forming portion except the adhesive-layer-exposed portion in the third direction, or the first length is less than or equal to a fifth length that is a longest length of the first indicator portion and the second indicator portion in the third direction.

16. The label medium according to claim 12, wherein the label comprises a cover portion that covers a portion of the adhesive-layer-exposed portion and that extends in a direction directed, from one of opposite ends of one of the first indicator portion and the second indicator portion which is connected to the other of the first loop forming portion and the second loop forming portion which does not comprise the adhesive-layer-exposed portion, toward the other of the opposite ends of the one of the first indicator portion and the second indicator portion.

17. The label medium according to claim 1, wherein the first line extends in the first direction.

18. The label medium according to claim 1, wherein the first line extends in a third direction orthogonal to the first direction and parallel with a widthwise direction of the mount sheet.

19. The label medium according to claim 1, wherein the first line is perforation.

20. The label medium according to claim 1, wherein the adhesive layer is provided on the label.

21. The label medium according to claim 1, wherein the mount sheet comprises a straight portion opposed to the first line and formed of one of perforation and a slit.

22. The label medium according to claim 1,
wherein the mount sheet has an elongated shape, and
wherein a plurality of labels each as the label are arranged in an elongated direction of the mount sheet and stuck to the mount sheet.

23. The label medium according to claim 1,
wherein a shape of combination of the label and a frame portion different from the label is identical to a shape of the mount sheet, and
wherein a slit is formed at a boundary between the label and the frame portion.

24. The label medium according to claim 1, wherein only the label is stuck to the mount sheet.

25. The label medium according to claim 1, wherein the first indicator portion and the second indicator portion are connected to each other via the first line.

26. The label medium according to claim 1,
wherein the label comprises at least one reinforcing portion configured to reinforce a wrapping portion formed by sticking the first wrapping portion and the second wrapping portion to each other, and
wherein the at least one reinforcing portion is connected via a second line to at least one of the first wrapping portion and the second wrapping portion at one or both of opposite edges of the at least one of the first wrapping portion and the second wrapping portion in the third direction.

27. The label medium according to claim 12,
wherein the label comprises at least one reinforcing portion configured to reinforce a loop forming portion formed by sticking the first loop forming portion and the second loop forming portion to each other, and
wherein the at least one reinforcing portion is connected to via a second line to at least one of the first loop forming portion and the second loop forming portion at one or both of opposite edges of the at least one of the first loop forming portion and the second loop forming portion in the third direction.

28. A cassette containing a roll that is formed by winding a label medium around a spool,
wherein the label medium comprises:
a mount sheet; and
a label stuck to the mount sheet via an adhesive layer and comprising (i) a first indicator portion and a second indicator portion each comprising a region on which information is directly printable or writable, (ii) a first wrapping portion and a second wrapping portion to be wrapped on a wrapped member, one of the first wrapping portion and the second wrapping portion comprising an adhesive-layer-exposed portion, and (iii) a first through portion and a second through portion each comprising at least a portion of a hole or a slit through which the adhesive-layer-exposed portion is passed,
wherein the first indicator portion, the first through portion, and the first wrapping portion are connected to each other in order of the first indicator portion, the first through portion, and the first wrapping portion in a first direction parallel with a surface of the mount sheet,
wherein the second indicator portion, the second through portion, and the second wrapping portion are connected to each other in order of the second indicator portion, the second through portion, and the second wrapping portion in one of the first direction and a second direction opposite to the first direction,
wherein at least one pair of (a) a pair of the first indicator portion and the second indicator portion, (b) a pair of the first through portion and the second through portion, or (c) a pair of the first wrapping portion and the second wrapping portion are connected to each other via a first line,
wherein at least a portion of the first indicator portion and at least a portion of the second indicator portion are symmetric with respect to an imaginary line extending along the first line,
wherein at least a portion of the first through portion and at least a portion of the second through portion are symmetric with respect to the imaginary line,
wherein at least a portion of the first wrapping portion and at least a portion of the second wrapping portion are symmetric with respect to the imaginary line,
wherein at least a portion of the hole or the slit of the first through portion and at least a portion of the hole or the slit of the second through portion are symmetric with respect to the imaginary line, and
wherein the first wrapping portion, the first through portion, and the first indicator portion are arranged in order of the first wrapping portion, the first through portion, and the first indicator portion in a direction directed from one of opposite ends of the label medium, which one is connected to the spool, toward the other of the opposite ends of the label medium, and
wherein the second wrapping portion, the second through portion, and the second indicator portion are arranged in order of the second wrapping portion, the second through portion, and the second indicator portion in the direction directed from the one of the opposite ends of the label medium toward the other of the opposite ends of the label medium.

29. A cassette containing a roll that is formed by winding a label medium around a spool,
wherein the label medium comprises:
a mount sheet; and
a label stuck to the mount sheet via an adhesive layer and comprising (i) a first indicator portion and a second indicator portion each comprising a region on which information is directly printable or writable and (ii) a first loop forming portion and a second loop forming portion for forming a loop, one of the first loop forming portion and the second loop forming portion comprising an adhesive-layer-exposed portion,
wherein the first indicator portion and the first loop forming portion are connected to each other and arranged in order of the first indicator portion and the first loop forming portion in a first direction parallel with a surface of the mount sheet,
wherein the second indicator portion and the second loop forming portion are connected to each other and arranged in order of the second indicator portion and the second loop forming portion in one of the first direction and a second direction opposite to the first direction,
wherein at least one pair of (a) a pair of the first indicator portion and the second indicator portion or (b) a pair of the first loop forming portion and the second loop forming portion are connected to each other via a first line,
wherein at least a portion of the first indicator portion and at least a portion of the second indicator portion are symmetric with respect to an imaginary line extending along the first line,
wherein at least a portion of the first loop forming portion and at least a portion of the second loop forming portion are symmetric with respect to the imaginary line,
wherein the first loop forming portion and the first indicator portion are arranged in order of the first loop forming portion and the first indicator portion in a direction directed from one of opposite ends of the label medium, which one is connected to the spool, toward the other of the opposite ends of the label medium, and
wherein the second loop forming portion and the second indicator portion are arranged in order of the second loop forming portion and the second indicator portion in the direction directed from the one of the opposite ends of the label medium toward the other of the opposite ends of the label medium.
